(19) United States
(12) Patent Application Publication
(10) Pub. No.: US 2026/0080748 A1
(43) Pub. Date: Mar. 19, 2026

(54) GAMING DEVICE WITH SPLITTING TRIGGER SYMBOLS

(71) Applicant: Aristocrat Technologies Australia PTY Limited, North Ryde (AU)

(72) Inventors: Geoffrey Richardson, Baulkham Hills (AU); Danny Winata, Oatlands (AU); Karen Kendall, Toongabbie (AU)

(21) Appl. No.: 18/957,364

(22) Filed: Nov. 22, 2024

(30) Foreign Application Priority Data
Sep. 18, 2024 (AU) 2024219857

(51) Int. Cl. G07F 17/32; G07F 17/34

(52) U.S. Cl. CPC G07F 17/3267; G07F 17/34

(57) ABSTRACT

A gaming device comprises a display, a random number generator, a processor, and a memory storing reel strips comprising trigger symbols and other game symbols and instructions. When the instructions are executed by the processor, they cause the processor to: select, in a game instance, using the random number generator, symbols from the reel strips for display at a plurality of columns of symbol positions; display the selected symbols at the symbol positions; and, upon a split condition being met in respect of at least one selected trigger symbol: modify display of each at least one selected trigger symbol for which a split condition is met to at least two trigger symbols at the respective symbol position; determine whether to trigger a feature game based on a displayed number of trigger symbols after the modification; and, upon making a determination to trigger the feature game, award the feature game.

### CROSS-REFERENCE TO RELATED APPLICATION

The present application claims priority to Australian Patent Application No. 2024219857, filed Sep. 18, 2024, and entitled, “Gaming Device with Splitting Trigger Symbols.”

### FIELD

The present application relates to a gaming device, a method of operating a gaming device and a system with splitting trigger symbols.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. Upon initiation of play, the RNG randomly determines a game outcome and symbols are then selected which correspond to that outcome. Notably, some games may include an element of skill on the part of the player and are therefore not entirely random.

### SUMMARY

An example embodiment describes a gaming device comprising an electronic display, a random number generator, a processor, and a memory storing (i) reel strips comprising trigger symbols and other game symbols; and (ii) instructions. When the instructions are executed by the processor, they cause the processor to select in a game instance, using the random number generator, symbols from the reel strips for display at a plurality of columns of symbol positions, control the electronic display to display the selected symbols at the symbol positions, and, upon a split condition being met in respect of at least one selected trigger symbol, modify display of each at least one selected trigger symbol for which a split condition is met, to at least two trigger symbols at the respective symbol position, determine, whether to trigger a feature game based on a displayed number of trigger symbols after the modification, and upon making a determination to trigger the feature game, award the feature game.

Another example embodiment describes a method of operating a gaming device comprising an electronic display, memory storing reel strips comprising trigger symbols and other game symbols, and a random number generator. The method comprises selecting in a game instance, using the random number generator, symbols from the reel strips for display at a plurality of columns of symbol positions, controlling the electronic display to display the selected symbols at the symbol positions, and, upon a split condition being met in respect of at least one selected trigger symbol, modifying display of each at least one selected trigger symbol for which a split condition is met, to at least two trigger symbols at the respective symbol position, determining, whether to trigger a feature game based on a displayed number of trigger symbols after the modification, and upon making a determination to trigger the feature game, awarding the feature game.

Another example embodiment describes a system comprising at least one electronic display, a random number generator, one or more processors, and memory storing (i) reel strips comprising trigger symbols and other game symbols; and (ii) instructions. When the instructions are executed by the one or more processors, they cause the one or more processors to select in a game instance, using the random number generator, symbols from the reel strips for display at a plurality of columns of symbol positions, control the at least one electronic display to display the selected symbols at the symbol positions, and, upon a split condition being met in respect of at least one selected trigger symbol, modify display of each at least one selected trigger symbol for which a split condition is met, to at least two trigger symbols at the respective symbol position, determine, whether to trigger a feature game based on a displayed number of trigger symbols after the modification, and upon making a determination to trigger the feature game, award the feature game.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIGS. 6 to 14 are example screen displays.

### DETAILED DESCRIPTION

There is disclosed a gaming device, a method of operating a gaming device and a system where after a trigger symbol is selected, that meets a split condition, for example, by being selected at a defined symbol position (e.g. a symbol position in a first column of symbol positions), a random determination is made to determine a number of trigger symbols into which the trigger symbol is split (e.g. two, three or four trigger symbols). Each trigger symbol after the split is used in a determination as to whether to trigger a feature game, for example, whether a total number of trigger symbols is at least a defined number of trigger symbols. In an example, the trigger symbols are prize symbols having an associated prize. In an example, one of the trigger symbols is associated with a progressive prize and when split, is split into a first trigger symbol corresponding to the progressive prize, and at least a second trigger symbol corresponding to a related bonus prize.

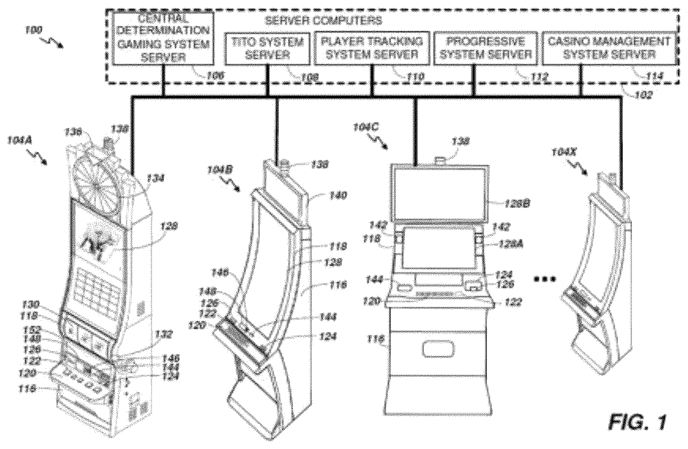

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

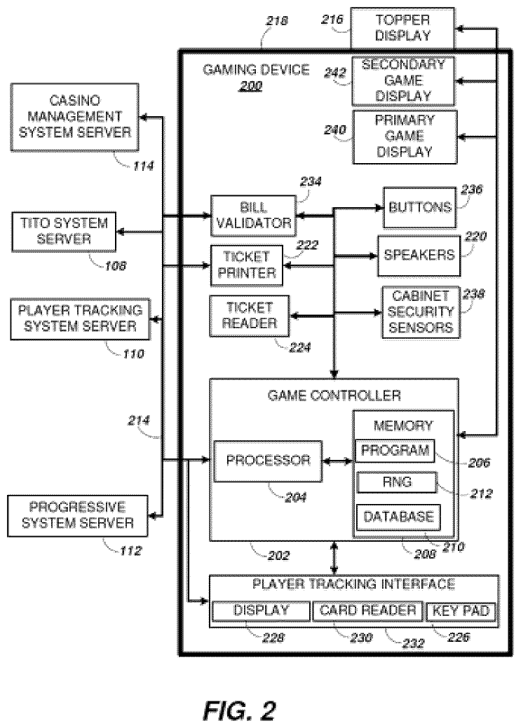

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

An example method of operating an EGM broadly involves conducting a base game in response to receipt of a wager by selecting symbols from reel strips, evaluating the selected symbols, and conducting a feature game if one is triggered.

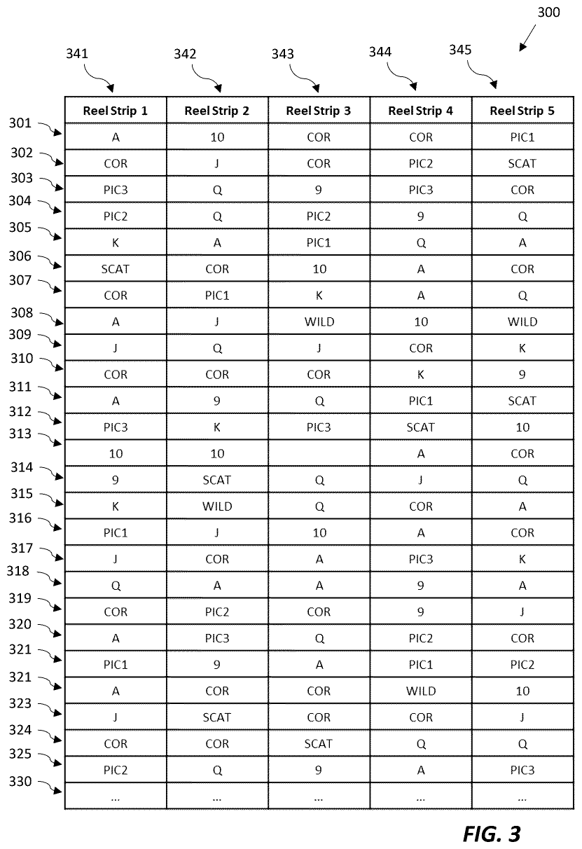

FIG. 3 shows example reel strips that illustrate the make-up of reel strips that may be used in the base game. FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a game symbol. For example, a “PIC1” symbol occupies the twenty-first reel strip position 321 of the fourth reel 344. The symbols shown on the reel strip are generally indicative of symbols that may be employed in the embodiments, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be), and volatility (in general, the higher the prize value is, the longer the reel strip needs to be to lower the hit rate). In some examples, the reel strips associated with different columns may be of different lengths to one another. In this example, the reel strips include Cash on Reel symbols “COR” symbols (for example, at second reel strip position 302 of first reel strip 341). As described further below, COR symbols are independently configured in each game instance to have one of a credit prize symbol (e.g. a credit value), a bonus prize symbol (e.g. Mini Bonus, Minor Bonus), or jackpot prize symbol (e.g. Major Jackpot, Grand Jackpot). Accordingly, the COR symbols can be understood to be prize symbols as they carry a prize. In this example, the COR are also trigger symbols for a hold and spin feature game as described in further detail below. The reel strips also include SCAT symbols (for example, at second reel strip position 302 of fifth reel strip 345) which are trigger symbols for a free games feature game.

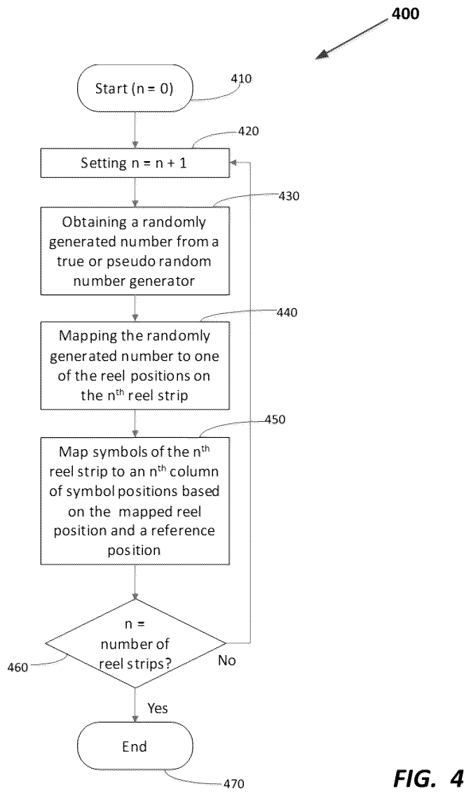

FIG. 4 is a flow chart of a general form of an example method 400 carried out by processor 204 to select symbols from r reel strips for r columns of a matrix of symbol positions - for example, five reel strips/columns.

In the example method shown in FIG. 4, at step 410, processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, processor 204 maps symbols of the nth reel strip to an nth column of symbol display positions based on the mapped reel position and a reference position. In an example, the reference position is the bottom position of the symbol positions of each column of symbol positions. Thus, in this example, the selected reel position (and hence the symbol at this position) is mapped to the bottom symbol position of the column and reel positions “above” the selected reel positions are mapped to symbol positions above the bottom symbol position in order to populate all symbol positions of the column. Referring to the example reel strips of FIG. 3, if the value returned by the RNG 212 is mapped to reel position 313 when, as in this example, three symbols are being selected for a first column of symbol positions then for the first reel strip 341, “10” is mapped to a first, bottom symbol position, “PIC3” symbol is mapped to a second symbol position, and “A” symbol is mapped to a third, top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470.

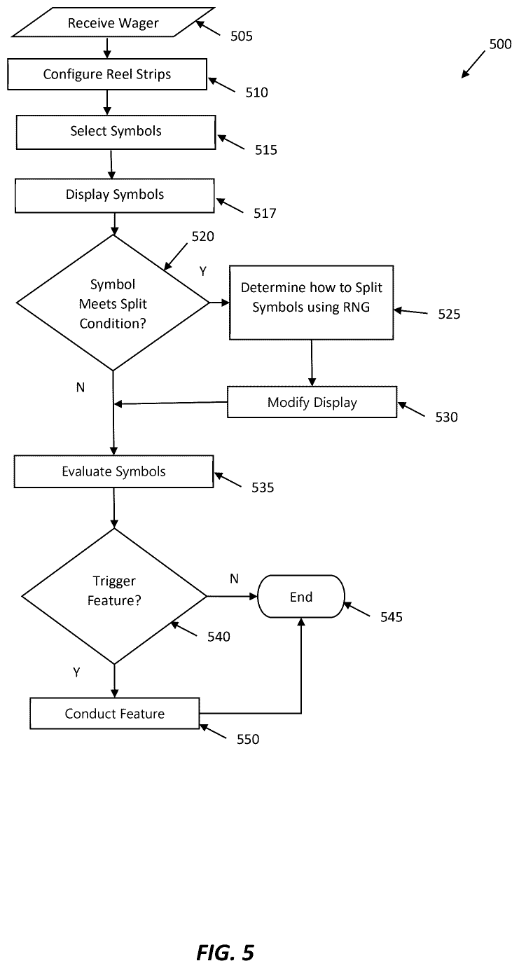

FIG. 5 is a flow chart of an example embodiment of a method 500 of operating a gaming device 200. At step 505, processor 204 initiates a base game instance in response to receiving a wager.

At step 510, processor 204 configures the reel strips for a current game instance. As indicated above, COR symbols are independently configured in each game instance to have one of a credit prize symbol (e.g. a credit value), a bonus prize symbol (e.g. Mini Bonus, Minor Bonus), or jackpot prize symbol (e.g. Major Jackpot, Grand Jackpot). In the configuration step 510, processor 204 uses random number generator 212 and a weight table in memory 208 to determine which of these symbols will be selected for a respective COR symbol position on the reel strips 341-342.

At step 515, processor 204 selects symbols from the reel strips 341-345 for a spinning reel base game using the process outlined above in connection with FIG. 4. At step 517, processor 204 controls the display 240 to display the selected symbols at respective symbol positions. In an example, processor 204 controls the display to animate each reel strip (from left to right) as spinning to the selected stop position.

At step 520, processor 204 determines whether the selected symbols include a trigger symbol that meets a split condition. In this example, the split condition is that a trigger symbol has been selected at a defined symbol position, in an example, any of the symbol positions in a first column of symbol positions such that there are a plurality of defined symbol positions. Upon a split condition being met, processor 204 proceeds to step 525 and conducts a random determination using the RNG 212 and a weight table stored in memory 208 to determine a number of trigger symbols into which the trigger symbol is to be split. In this example, processor 204 determines whether to split the trigger symbol into two, three or four trigger symbols. In other examples, the processor 204 may split the trigger symbol into a different number of trigger symbols. For example, two or three trigger symbols, two or four trigger symbols, etc. In some examples, determining whether the trigger symbol meets a split condition may include conducting a random determination as to whether the trigger symbols should be split using the RNG 212 and a further weight table.

In the flow chart of FIG. 5, step 520 is shown as being conducted after step 517, however, it will be appreciated that as the symbols are already selected at step 515, steps 520 and 525 may be conducted before step 517 or in parallel with step 517 (e.g. while processor 204 is controlling the animated reel strips to spin to a stop).

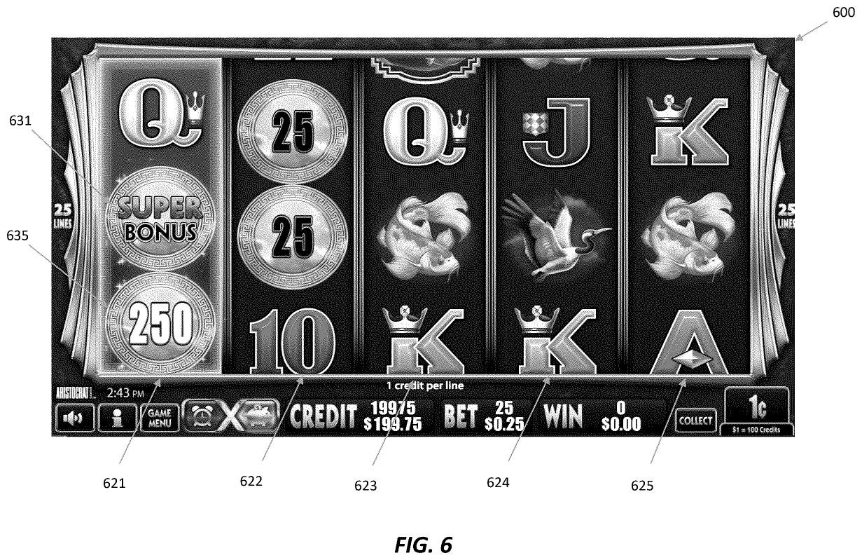

FIG. 6 shows an example screen display 600 during a base game, where symbols are selected for three symbol positions in each of five columns 621-625. Example screen display 600 is captured at a moment where processor 204 has controlled a first reel strip to spin to a stop at a selected position in a first column 621 while the remaining reel strips continue to be animated as spinning. In this example, the symbols selected by processor 204 for first column 621 include two trigger symbols 631, 635. In this example, “Super Bonus” prize symbol 631 corresponding to a “Super Bonus” prize, and “250 Credit” prize symbol 635. Accordingly, in this example, processor 204 will make a positive determination at step 520 and proceed to step 525 and determine, independently in respect of each of each of the trigger symbols 631,635 as to how many trigger symbols they will be split into. In this example, processor 204 determines at step 525 to split the Super Bonus symbol into two Super Bonus symbols and the 250 Credit prize symbol into three 250 credit symbols.

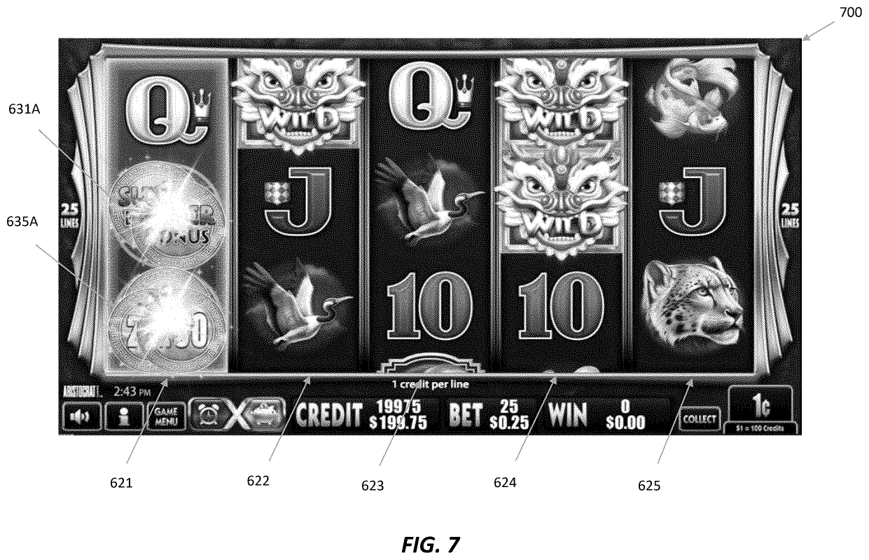

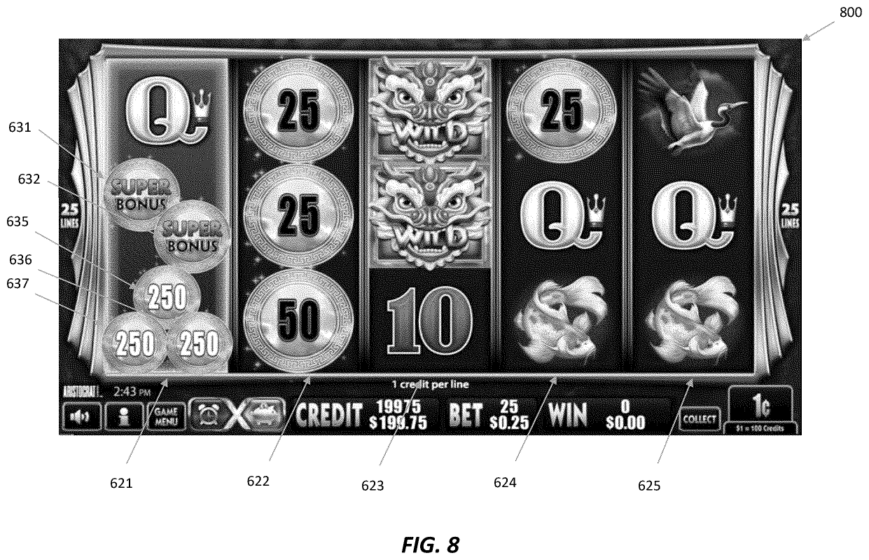

At step 530, processor 204 modifies the display 240 to show the additional trigger symbols while the remaining reel strips continue to be animated as spinning as illustrated by FIGS. 7 and 8. The example screen display 700 of FIG. 7 shows modified displays of trigger symbols 631A,635A as processor 204 animates a splitting of the trigger symbols while the remaining reels are continued to be animated as spinning. The example screen display 800 of FIG. 8, shows the trigger symbols after the processor 204 has completed modifying the display; in this example, such that there are two Super Bonus trigger symbols 631,632 and three 250 Credit symbols 635,636,637. Accordingly, before the split, there are two trigger symbols in the first column 621 and after the split there are five trigger symbols in the first column 621.

At step 535, the processor 204 evaluates the selected symbols for winning symbol combinations based on a pay table defined in the memory 208. In this example, the processor 204 applies a pay lines based evaluation in which defined pay lines comprising one symbol position from each column of symbol positions are evaluated from left to right. In an example, if a player selects all the pay lines as part of their wager, there 25 pay lines are evaluated.

At step 540, processor 204 determines whether a trigger condition is met in respect of the base game based on the number of trigger symbols after the feature game. If a trigger condition is not met, the game ends 545. In an example, the trigger condition may be that a defined minimum number of trigger symbols have been selected, for example, six trigger symbols. Accordingly, in the example of FIG. 8 where following the modification there are the five trigger symbols in the first column 621 of symbol positions, three trigger symbols in the second column 622, and one trigger symbol in the fourth column, the feature game will be triggered. Accordingly, it will be appreciated, that an advantage of splitting the trigger symbols is that it allows more trigger symbols to be counted toward triggering the feature game.

In this example, the feature game that is triggered is a hold and spin feature game in which the prize symbols (CORs) selected in the base game are held in place for the hold and spin feature game and additional game instances are conducted during which further prize symbols may be collected. An award for the hold and spin feature game is based on the prize symbols collected by the end of the additional game instances. Accordingly, as the trigger symbols are also prize symbols, splitting the trigger symbols also advantageously increases an award from collected prize symbols.

In other examples, the trigger symbols may be for another type of feature game such that there is no requirement for them to also be prize symbols.

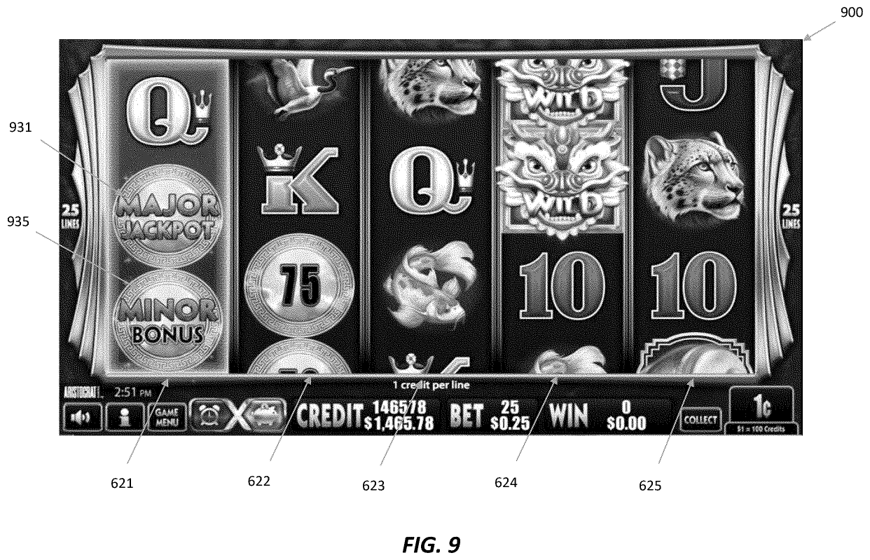

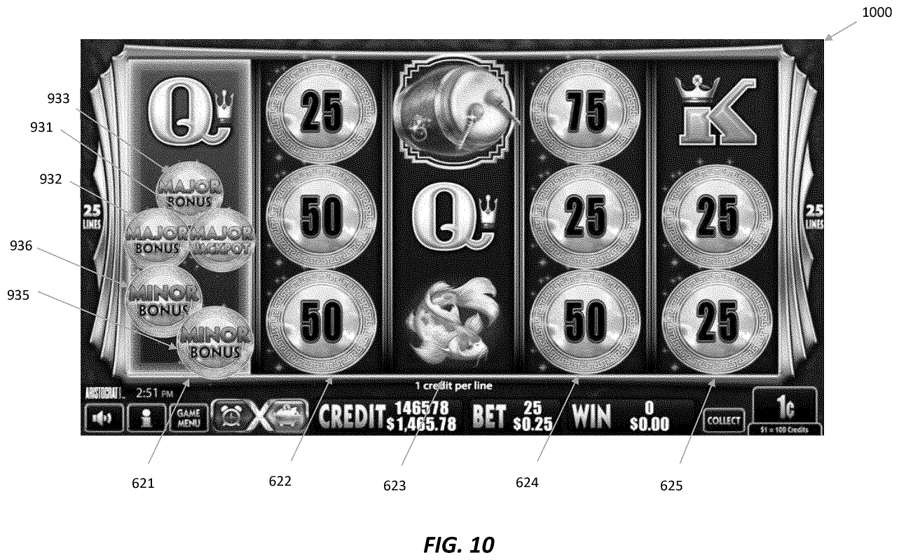

FIGS. 9 and 10 illustrate a further example of splitting trigger symbols that illustrate an example where one of the prize symbols corresponds to a progressive prize. In this example, as shown in example screen display 900 of FIG. 9, processor 204 has selected two trigger symbols 931,932 at the defined symbol positions in the first column 621. In this example, a first trigger symbol in the form of “Major Jackpot” prize symbol 931 and a second trigger symbol in the form of “Minor Bonus” prize symbol 935. In this example, the Minor Bonus prize is a set prize, whereas the Major Jackpot prize is a progressive jackpot that increments based on turnover on the current gaming device. In another example, the trigger symbol may correspond to a progressive jackpot incremented based on a plurality of connected gaming devices.

In this example, example modified screen display 1000 of FIG. 10 shows that at step 525 processor 204 has determined to split the first trigger symbol 931 into three trigger symbols 931-933 and second trigger symbol 935 into two trigger symbols 935,936. In this example, second trigger symbol 935 has modified two Minor Bonus prize symbols 935, 936, however, first trigger symbol 931 has been modified to be a Major Jackpot prize symbol corresponding to the progressive Major Jackpot and two fixed, Major Bonus prize symbols 932,933 which may result in the award of a Major Bonus prize following conduct of the hold and spin feature game. In conventional games, additional consideration must be given when a jackpot multiplier is offered, e.g., in terms of how the jackpot will be funded. For example, conventionally, a progressive jackpot is funded from a predetermined portion of the amount of “coin-in” (i.e., the amount of credit put into the machine by players over time) and, in the case of a common mystery jackpot, may be paid out when the value of the jackpot exceeds a randomly-selected threshold. Therefore, if game offers a jackpot multiplier, it cannot retroactively obtain an additional jackpot contribution to fund the multiplied jackpot, i.e., once the jackpot has been triggered. Conventionally, this problem is solved through the use of a so-called “phantom” jackpot, i.e. a jackpot value that the gaming device's controller keeps a track of, but which the player cannot see and does not know exists.

Turning back to FIG. 10, as mentioned above, in the case of the split symbols 931-933, the initial “Major Jackpot” symbol splits into multiple “Major Bonus” symbols. This effectively removes the “progressive” nature from the multiplied amounts. In other words, the player wins the original jackpot plus multiples of a fixed bonus. Therefore, using multiples of a fixed bonus simplifies implementation of the multiplied jackpot feature because the fixed amount can be calculated and accounted for as part of the standard game math—and does not itself need to be funded progressively (i.e., via a portion of coin-in). Advantageously, this allows a Major Jackpot prize symbol to be included in the trigger symbols without interfering with, or complicating, the mechanism for funding the progressive jackpot prize. Further advantageously, since the mechanism for funding progressive jackpots does not change, EGMs may be switched easily between a standalone jackpot configuration (i.e., where a single EGM funds its own jackpot) or a linked jackpot configuration (i.e., where multiple EGMs contribute to the jackpot) when deployed in the field. As may now be appreciated, the various symbol splitting techniques disclosed herein thus present a technical solution to the technical problem of being able to switch EGMs in the field between standalone and linked configurations on-the-fly—a feature that would not have been possible with past EGM software designs.

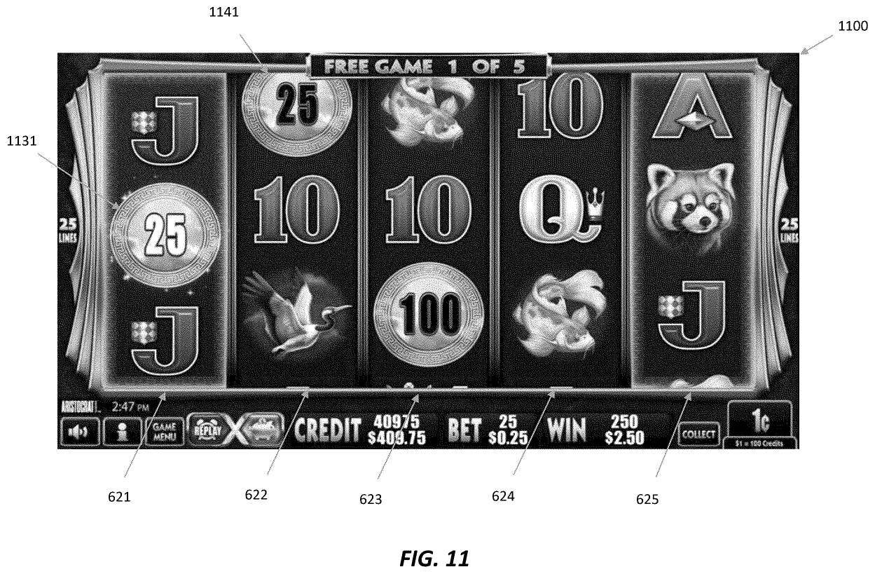

FIGS. 11 to 14 illustrate that triggers symbols may be split in other game states, in this example during a free game feature. As indicated above SCAT symbols may trigger a free game feature, comprising a plurality of free game instances. For example, via an additional determination as part of step 540. In an example, the number of free games may depend on a number of SCAT symbols selected in a base game. FIG. 11 to 14 also illustrate that different defined symbol positions to those described above may be used and that the defined symbol positions may depend on a game state. More broadly, FIGS. 11 to 14 illustrate that different split conditions to that described above may be used in some examples.

In an example, the defined symbol positions during the free games feature are the symbols positions of the first and fifth columns 621,625 of symbol positions. FIG. 11 shows an example screen display 1100 where a trigger symbol, here a “25 Credit” prize symbol 1131 has been selected for the first column 621 of symbol positions during a free game. It will be observed that, in this example, trigger symbols that can be split, such as trigger/prize symbol 1131 are distinguished from other trigger symbols, such as trigger/prize symbol 1141 by the colour used to denote the prize value. In this example, white for splitable symbols and black for trigger/prize symbols that do not split.

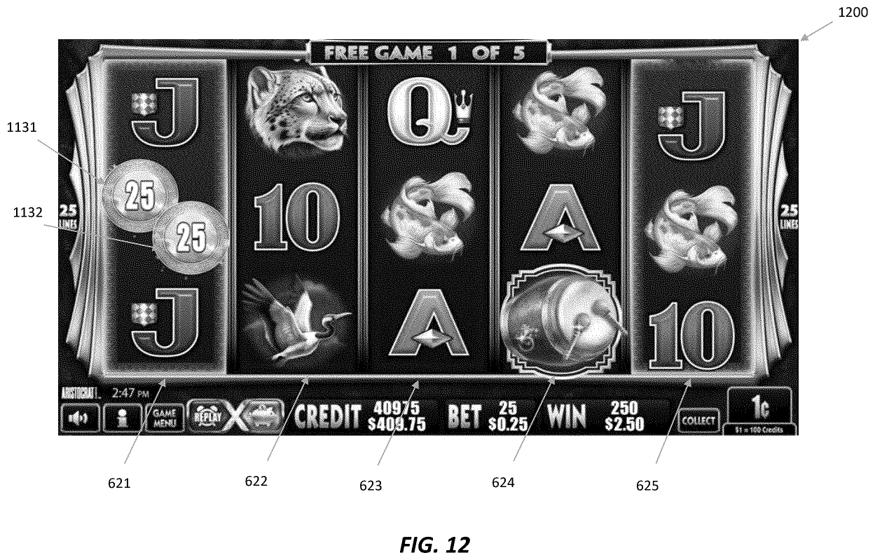

In the example of FIG. 11, processor 204 will make a positive determination at step 520, and in this example, determines at step 525 to split the trigger symbol 1131 into two trigger symbols 1131,1132 as shown in the modified screen display 1200 of FIG. 12.

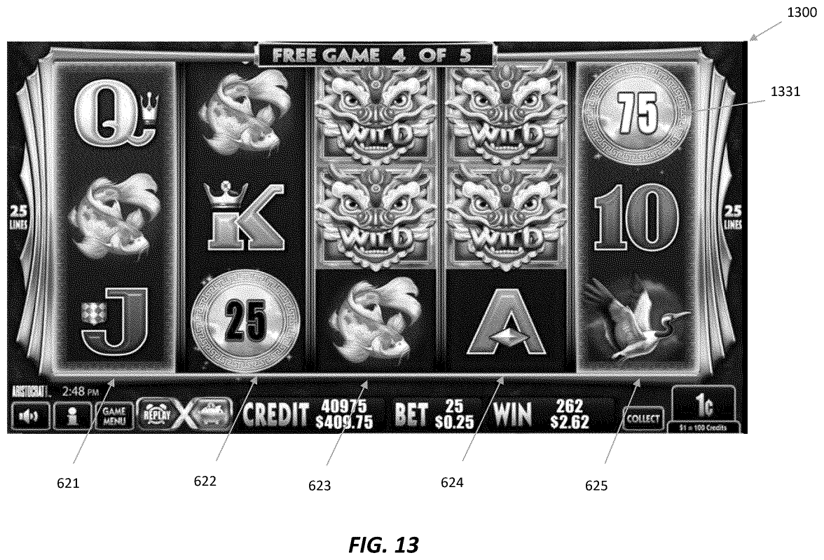

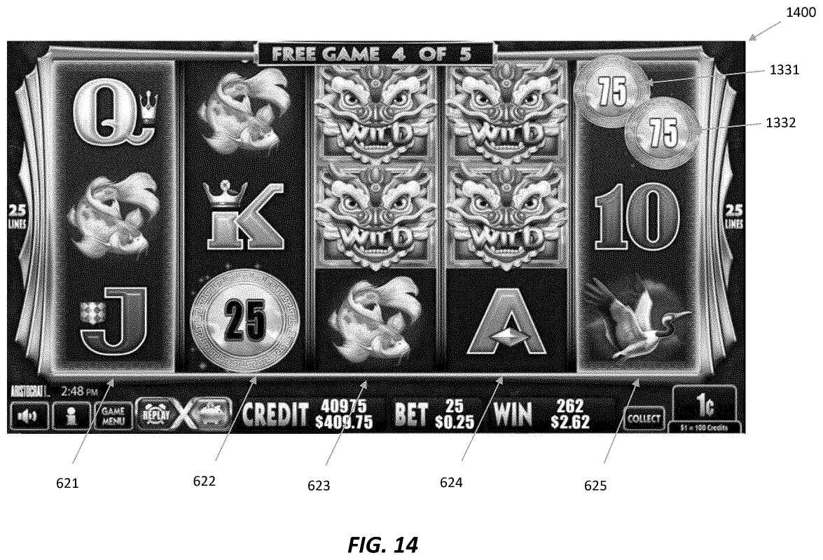

FIG. 13 shows an example screen display where a trigger symbol, here a “75 Credit” prize symbol 1331 has been selected for the fifth column 625 of symbol positions during a free game. In the example of FIG. 13, processor 204 will also make a positive determination at step 520, and in this example, also determines at step 525 to split the trigger symbol 1331 into two trigger symbols 1331,1332 as shown in the modified screen display 1400 of FIG. 14.

In the examples of FIGS. 11 to 14, processor 204 determines after the split whether to award the hold and spin feature game based on the number of trigger symbols after the modification. In an example, if the hold and spin feature game is triggered, it may be awarded and then conducted at the conclusion of the free games feature.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. A gaming device comprising:
an electronic display;
a random number generator;
a processor; and
memory storing (i) reel strips comprising trigger symbols and other game symbols; and (ii) instructions which, when executed by the processor, cause the processor to:
select in a game instance, using the random number generator, symbols from the reel strips for display at a plurality of columns of symbol positions;
control the electronic display to display the selected symbols at the symbol positions; and
upon a split condition being met in respect of at least one selected trigger symbol:
modify display of each at least one selected trigger symbol for which a split condition is met, to at least two trigger symbols at the respective symbol position,
determine, whether to trigger a feature game based on a displayed number of trigger symbols after the modification, and
upon making a determination to trigger the feature game, award the feature game.

2. The gaming device as claimed in claim 1, wherein, when the instructions are executed by the processor, they cause the processor to modify display of each at least one selected trigger symbol for which a split condition is met, to at least two trigger symbols, by selecting, using the random number generator, between at least two different numbers of trigger symbols.

3. The gaming device as claimed in claim 2, wherein the at least two numbers of symbol positions are two, three, and four trigger symbols.

4. The gaming device as claimed in claim 1, wherein the split condition comprises the trigger symbol being selected for a defined symbol position.

5. The gaming device as claimed in claim 4, wherein there are a plurality of defined symbol positions.

6. The gaming device as claimed in claim 5, wherein the plurality of defined symbol positions is dependent on a game state.

7. The gaming device as claimed in claim 6, wherein when the game state is a base game such that the game instance is a base game instance, the plurality of defined symbol positions correspond to one column of symbol positions.

8. The gaming device as claimed in claim 6, wherein when the game state is a free games feature such that the game instance is a free game instance of a plurality of free game instances, the plurality of defined symbol positions correspond to two columns of symbol positions.

9. The gaming device as claimed in claim 1, wherein each trigger symbol is a prize symbol.

10. The gaming device as claimed in claim 9, wherein, when the instructions are executed by the processor, they cause the processor to, upon a trigger symbol meeting a split condition being a progressive prize symbol, modify display of the trigger symbol to a first progressive prize symbol, and at least one fixed prize symbol.

11. A method of operating a gaming device comprising an electronic display, memory storing reel strips comprising trigger symbols and other game symbols, and a random number generator, the method comprising:
selecting, in a game instance and using the random number generator, symbols from the reel strips for display at a plurality of columns of symbol positions;
controlling the electronic display to display the selected symbols at the symbol positions; and
upon a split condition being met in respect of at least one selected trigger symbol:
modifying display of each at least one selected trigger symbol for which a split condition is met, to at least two trigger symbols at the respective symbol position;
determining, whether to trigger a feature game based on a displayed number of trigger symbols after the modification; and
upon making a determination to trigger the feature game, awarding the feature game.

12. The method as claimed in claim 11, wherein modifying display of each at least one selected trigger symbol for which a split condition is met, to at least two trigger symbols, by selecting, using the random number generator, between at least two different numbers of trigger symbols.

13. The method as claimed in claim 12, wherein the at least two numbers of symbol positions are two, three, and four trigger symbols.

14. The method as claimed in claim 11, wherein the split condition comprises the trigger symbol being selected for a defined symbol position.

15. The method as claimed in claim 14, wherein there are a plurality of defined symbol positions.

16. The method as claimed in claim 15, wherein the plurality of defined symbol positions is dependent on a game state.

17. The method as claimed in claim 16, wherein when the game state is a base game such that the game instance is a base game instance, and wherein the plurality of defined symbol positions correspond to one column of symbol positions.

18. The method as claimed in claim 16, wherein, when the game state is a free games feature such that the game instance is a free game instance of a plurality of free game instances, the plurality of defined symbol positions correspond to two columns of symbol positions.

19. The method as claimed in claim 11, comprising. upon a trigger symbol meeting a split condition being a progressive prize symbol, modifying display of the trigger symbol to a first progressive prize symbol and at least one fixed prize symbol.

20. A system comprising:
at least one electronic display;
a random number generator;
one or more processors; and
memory storing: (i) reel strips comprising trigger symbols and other game symbols; and (ii) instructions which, when executed by the one or more processors, cause the one or more processors to:
select, in a game instance and using the random number generator, symbols from the reel strips for display at a plurality of columns of symbol positions;
control the at least one electronic display to display the selected symbols at the symbol positions; and
upon a split condition being met in respect of at least one selected trigger symbol:
modify display of each at least one selected trigger symbol for which a split condition is met to at least two trigger symbols at the respective symbol position;
determine whether to trigger a feature game based on a displayed number of trigger symbols after the modification; and
upon making a determination to trigger the feature game, award the feature game.
